(19) United States
(12) Patent Application Publication
(10) Pub. No.: US 2014/0304261 A1
(43) Pub. Date: Oct. 9, 2014

(54) Web Page Ranking Method, Apparatus and Program Product

(71) Applicant: INTERNATIONAL BUSINESS MACHINES CORPORATION, Armonk, NY (US)

(72) Inventors: Barry A. Kritt, Raleigh, NC (US); Sarbajit K. Rakshit, Dusseldorf (GE)

(73) Assignee: International Business Machines Corporation, Armonk, NY (US)

(21) Appl. No.: 13/858,423

(22) Filed: Apr. 8, 2013

(51) Int. Cl. G06F 17/30

(52) U.S. Cl. CPC G06F 17/3053
USPC 707/728

(57) ABSTRACT

Web pages accessed as results obtained from search engines which locate documents or web pages or web sites in a computer network (e.g., a distributed system of computer systems), are displayed in a ranked order. The ranked order improves the relevance of displayed web pages to a search inquiry entered by a user of an end user device such as a personal computer system, a tablet, a smartphone or other device. The method, apparatus and program product identifies reference pages based on source code analysis; how many times any page is referred in different pages; and what amount of content is referred in any document. The reputation of any referred page is assessed. This information is used to calculate a score of any web page, with a better score resulting in higher ranking.

### FIELD AND BACKGROUND OF INVENTION

The present invention relates generally to the field of displaying results obtained from search engines which locate documents or web pages or web sites in a computer network (e.g., a distributed system of computer systems), and in particular, to a method, apparatus and program product for displaying accessed web pages in a ranked order. The ranked order improves the relevance of displayed web pages to a search inquiry entered by a user of an end user device such as a personal computer system, a tablet, a smartphone or other device.

In internet searching, web page ranking will help any user to find an appropriate page more quickly. There are many instances where a web page will support the content on the page by listing reference web pages or URLs. For example, a web page may relate to a biography of a famous person. The originator or writer of the web page collects different information about the person from different web pages and identifies those pages as reference pages for the biography, such as by a footnote or listing in a Reference section of the web page. One purpose of providing such reference pages is to support the authenticity and accuracy of the information presented. Another purpose is to provide additional information beyond that included in the web page. If any page is referred to in multiple other pages, then it is indicative that the referenced page has value, and will be useful for other users in conducting an internet search. An improvement in web page ranking would mean a better search result would be displayed near or at the top of displayed search results. Thus there is an opportunity to improve page ranking of any page based on reference pages identified.

### SUMMARY OF THE INVENTION

What is here taught is a method, an apparatus and a program product which generates at a user's computer system a display of search results in which the results are displayed with more highly relevant results being given priority. Such priority may be by placement at or near the top of any listing of results or by otherwise “tagging” the results as having the potential of greater significance to the search query posed. In pursuing this objective, the method apparatus and program product taught here follow steps of responding to entry of a search query by a computer user into a search program executing on a computer system having a processor and memory by accessing a plurality of web pages and then operating on the data of each of the plurality of accessed web pages to ultimately rank web pages for display. The technology disclosed contemplates that the ranking occur by determining other web pages to which reference is made from an accessed web page, determining the relevance of the referenced other web pages to the content of the accessed web page, ordering the accessed web pages into a ranked order based upon the relevance of the referenced other web pages to an accessed web page, with higher rank being given to accessed web pages to which the referenced other web pages have greater relevance, and finally displaying the plurality of accessed web pages to the computer user in ranked order, with higher ranked web pages being given priority in display.

### BRIEF DESCRIPTION OF DRAWINGS

Some of the purposes of the invention having been stated, others will appear as the description proceeds, when taken in connection with the accompanying drawings, in which:

FIG. 1 is an illustration of a computer system such as would be used by a person exercising the invention described here;

FIGS. 2 and 3 are representations of the flow of processes in accordance with this teaching and which are implemented by execution of computer code on an information handling system such as that of FIG. 1;

FIGS. 4 through 6 are illustrations of certain of the steps of the processes in accordance with this teaching;

FIG. 7 is an illustration of a non-transistory, tangible computer readable media having embodied therein computer readable program code for providing and facilitating the capabilities of the processes of FIGS. 2 and 3.

### DETAILED DESCRIPTION OF INVENTION

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of the invention. Accordingly, the description which follows is to be understood as being a broad, teaching disclosure directed to persons of skill in the appropriate arts, and not as limiting upon the present invention.

The term “circuit” or “circuitry” may be used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

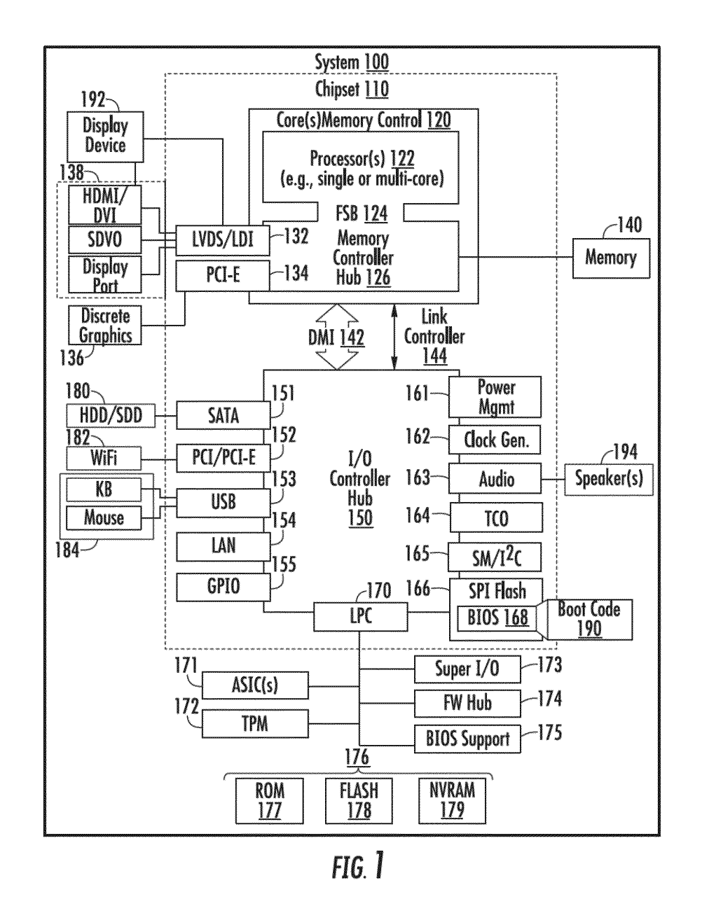

While various exemplary circuits or circuitry are discussed, FIG. 1 depicts a block diagram of an illustrative exemplary computer system 100. The system 100 may be a desktop computer system or a workstation computer; however, as apparent from the description herein, a client device, a server or other machine may include other features or only some of the features of the system 100.

The system 100 of FIG. 1 includes a so-called chipset 110 (a group of integrated circuits, or chips, that work together, chipsets) with an architecture that may vary depending on manufacturer (e.g., INTEL®, AMD®, etc.). The architecture of the chipset 110 includes a core and memory control group 120 and an I/O controller hub 150 that exchange information (e.g., data, signals, commands, etc.) via a direct management interface (DMI) 142 or a link controller 144. In FIG. 1, the DMI 142 is a chip-to-chip interface (sometimes referred to as being a link between a “northbridge” and a “southbridge”). The core and memory control group 120 include one or more processors 122 (e.g., single or multi-core) and a memory controller hub 126 that exchange information via a front side bus (FSB) 124; noting that components of the group 120 may be integrated in a chip that supplants the conventional “northbridge” style architecture.

In FIG. 1 the memory controller hub 126 interfaces with memory 140 (e.g., to provide support for a type of RAM that may be referred to as “system memory”). The memory controller hub 126 further includes a LVDS interface 132 for a display device 192 (e.g., a CRT, a flat panel, a projector, etc.). A block 138 includes some technologies that may be supported via the LVDS interface 132 (e.g., serial digital video, HDMI/DVI, display port). The memory controller hub 126 also includes a PCI-express interface (PCI-E) 134 that may support discrete graphics 136. In FIG. 1, the I/O hub controller 150 includes a SATA interface 151 (e.g., for HDDs, SDDs, etc.), a PCI-E interface 152 (e.g., for wireless connections 182), a USB interface 153 (e.g., for input devices 184 such as keyboard, mice, cameras, phones, storage, etc.), a network interface 154 (e.g., LAN), a GPIO interface 155, a LPC interface 170 (for ASICs 171, a TPM 172, a super I/O 173, a firmware hub 174, BIOS support 175 as well as various types of memory 176 such as ROM 177, Flash 178, and NVRAM 179), a power management interface 161, a clock generator interface 162, an audio interface 163 (e.g., for speakers 194), a TCO interface 164, a system management bus interface 165, and SPI Flash 166, which can include BIOS 168 and boot code 190. The I/O hub controller 150 may include gigabit Ethernet support.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168. As described herein, a device may include fewer or more features than shown in the system 100 of FIG. 1.

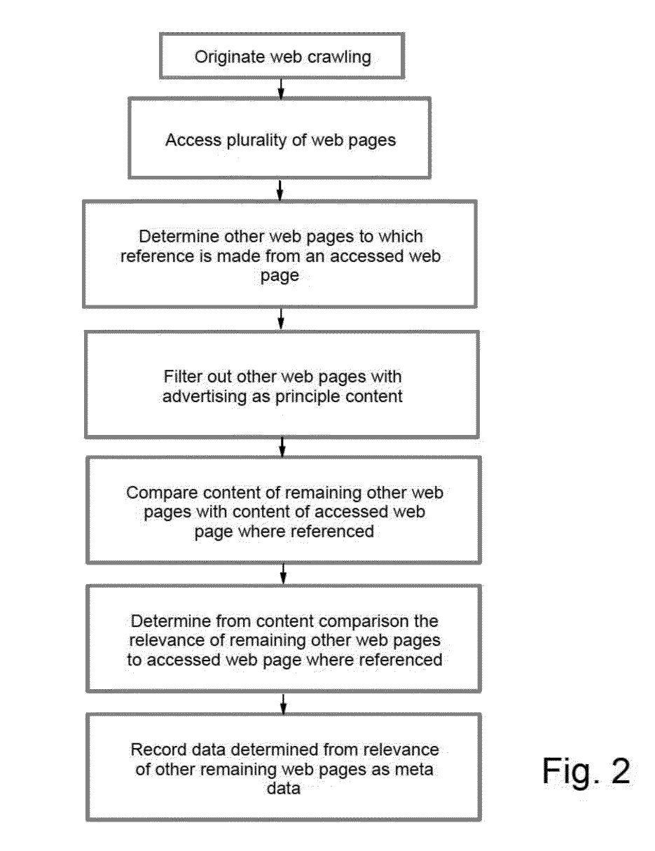

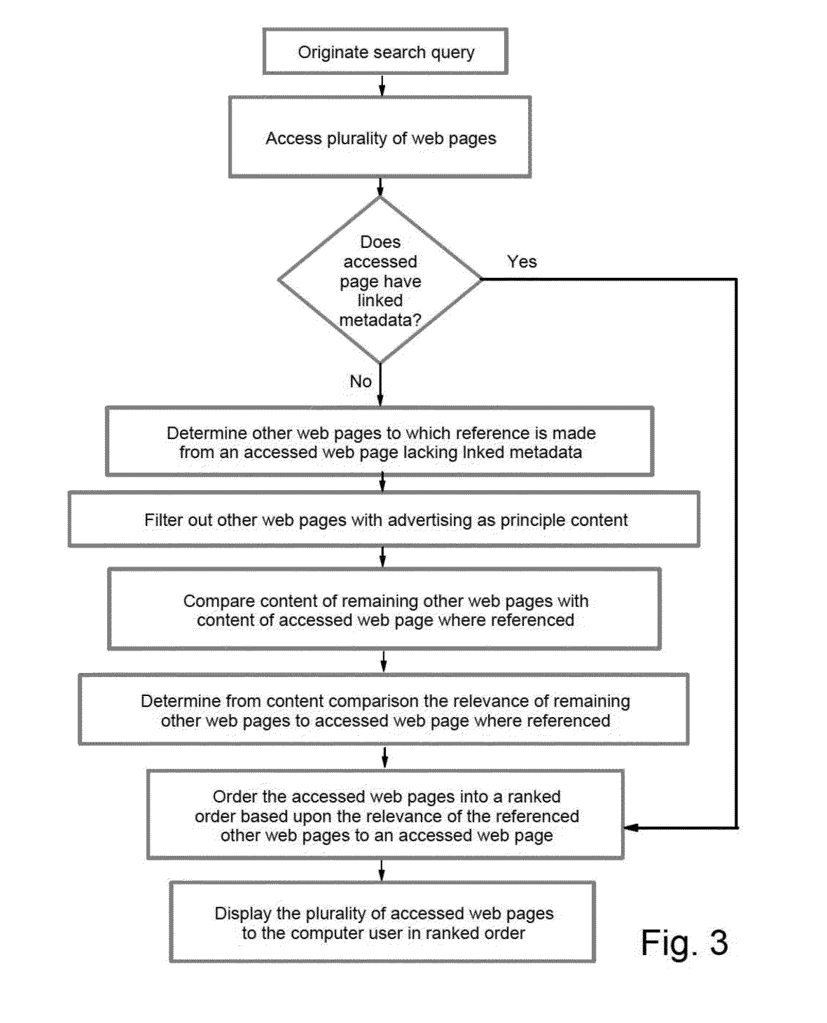

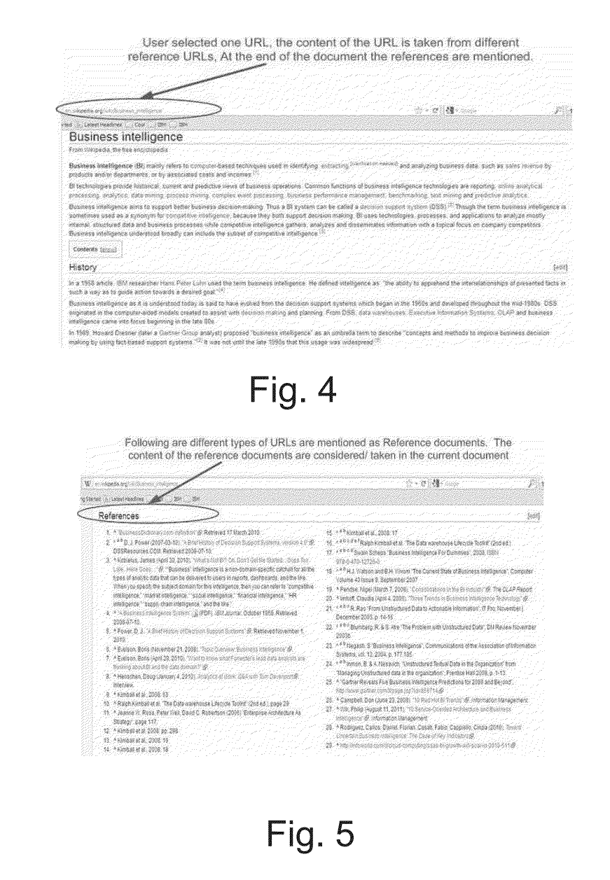

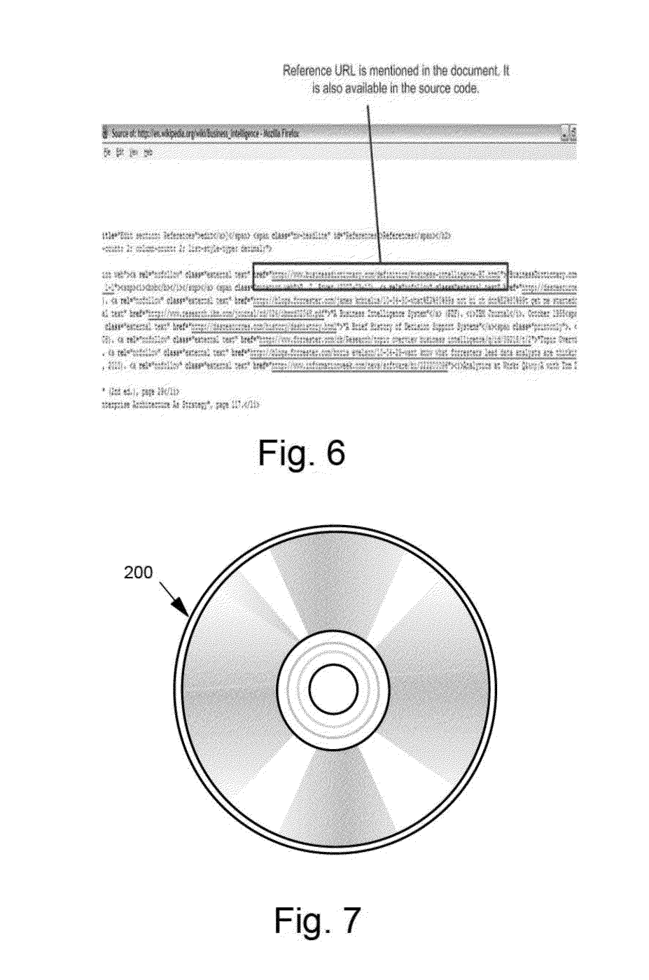

Referring now more particularly to FIGS. 2 through 5, the steps in implementing what is taught here will now be described. The process begins with the origination of a search inquiry by an end user. The query will cause the accessing of a plurality of web pages, the content of which responds to a greater or lesser degree to the query. As an example only, should the query be about “Business intelligence”, one of the accessed web pages (among many) would be a page from wikipedia.com, the online encyclopedia (see FIG. 3). The wikipedia web page, as is typical of many others, will have a reference section near the end of the page when displayed (see FIG. 4). The reference section lists other web pages with content which the wikipedia author believes pertinent to the subject, Business intelligence. Other accessed web pages may embed such references into the main text. In either event, the references to other web pages will, in order to enable display, include data in the code for the accessed web page which identifies the other, referenced, web pages (see FIG. 5).

Once the accessed web pages are determined by the response to the search query, then the accessed web pages are analyzed for referenced other web pages. As such referenced other web pages are identified, the code of those pages is analyzed for inclusion of apparent advertising messages embedded in the web pages. If advertising content is detected, then the web page is filtered out from further operations, on the basis that the advertising content is less relevant to the initial search query.

After filtering out advertising web pages, the remaining other, referenced, web pages are analyzed for a comparison of the web page content between the accessed web page and the other, referenced, web page. From the comparison, the process then determines the comparative relevance of the other web pages to the accessed web page from which the reference was discovered. A high degree of relevance between the accessed web page and the other, referenced, web page is deemed indicative of the quality of the data in the accessed web page.

Background web crawling of the web sites identified in advance of an original search query will be used by search engine providers to predetermine the number of references to a URL or referenced web page (FIG. 2). It is here contemplated that if a web page identified in such a web crawl (page A) references another (page B) then as web crawling takes place and as the source code for Page A is processed, the metadata information maintained for Page B is updated (either just updating a count of referring URLs, or actually keeping a list of all the URLs that point to Page B). As web crawling is completed, all the pages identified in response to the web crawling would already have information on the number of URLs that point to them to use for ranking. For example above, if Page B is one of the results of a search, it would already have metadata that Page A (and others) referenced it versus trying to discover it when a user is doing the search. This approach is faster and ensures capturing all of the pages that refer to Page B (since any particular focused web search may only capture a subset of pages that refer to Page B depending on the original search terms).

Upon initiation of a focused web search, beginning with a specific query, the web sites identified in response to an original search query will be used by search engine providers to access a number of web pages and determine whether some of the pages have associated metadata gathered from advance web crawling. If so, then pages with associated metadata may go directly into the ranking (FIG. 3). For pages as to which no associated metadata is found, the process proceeds down the steps as if a anticipatory crawl has been done. That is, if a web page identified in such a web crawl following a focused search (page A) references another (page B) then as web crawling takes place and as the source code for Page A is processed, the metadata information maintained for Page B is updated (either just updating a count of referring URLs, or actually keeping a list of all the URLs that point to Page B). As the focused search is completed, all the pages identified in response to the query would have information on the number of URLs that point to them to use for ranking. For example above, if Page B is one of the results of a search, it would already have metadata that Page A (and others) referenced it versus trying to discover it when a user is doing the search. This approach is faster and ensures capturing all of the pages that refer to Page B (since any particular focused web search may only capture a subset of pages that refer to Page B depending on the original search terms).

The accessed web pages identified in the original search query are then ordered into a ranked order based upon several factors. These are: the reputation of the main or accessed web page; the number of times any of the other, referenced web pages are referred to in all of the accessed web pages; and the degree of relevance of any referenced other web page to a main or accessed web page. That is, as to reputation, the main or accessed web page is given a score of between 1 and 10 based upon the number of reference pages identified from that web page. An accessed web page (one originally identified in response to the search query) which has no referenced other web pages receives a score of 1. The accessed web page with the greatest number of referenced other web pages receives a score of 10. A referenced web page which is identified in only one accessed web page receives a score of 1. A referenced web page identified in a number of accessed web pages receives a higher score, up to 10. A referenced web page which has little relevance to the main or accessed page on which it was identified as a reference receives a score of 1. A referenced web page which has high relevance to the main or accessed web page receives a score of 10.

Having assigned scores by analysis, each of the main or accessed web pages is then assigned a final score in accordance with a formula. Where the reputation score is identified as R, the number of citations of a referenced web page is identified as N, and the relevance score is identified as D, the formula is a computation of every combination of R, N and D for the accessed web pages. That is, the score of an accessed web page (one initially identified in response to the search query) is a sum of R₁ X N₁ X D₁ et seq. Every combination of R, N and D is calculated. Once calculated, the total score of every accessed web page is determined. The web pages are then ordered into rank order, and those web pages with the highest rank are given priority in display to the end user who originated the search query. Such priority in display may be by display at the top of a list of returned web pages or by some signal that a page or pages deserve more immediate or closer attention than do others returned in response to the search query.

While discussed to this point from the perspective of the process of ranking returned web pages, it will be understood that the process is accomplished by execution of computer program instructions on an apparatus such as that of FIG. 1 discussed above.

One or more aspects of the present invention can be included in an article of manufacture (e.g., one or more computer program products) having, for instance, non-transistory, tangible computer readable media, indicated at 200 in FIG. 7. The media has embodied therein, for instance, computer readable program code for providing and facilitating the capabilities of the present invention. The article of manufacture can be included as a part of a computer system or sold separately. Machine readable storage mediums may include fixed hard drives, optical discs such as the disc 200, magnetic tapes, semiconductor memories such as read only memories (ROMs), programmable memories (PROMs of various types), flash memory, etc. The article containing this computer readable code is utilized by executing the code directly from the storage device, or by copying the code from one storage device to another storage device, or by transmitting the code on a network for remote execution.

In the drawings and specifications there has been set forth a preferred embodiment of the invention and, although specific terms are used, the description thus given uses terminology in a generic and descriptive sense only and not for purposes of limitation.

What is claimed is:

1. Method comprising:
responding to entry of a search query by a computer user into a search program executing on a computer system having a processor and memory by accessing a plurality of web pages;
operating on the data of each of the plurality of accessed web pages to:
determine other web pages to which reference is made from an accessed web page;
determine the relevance of the referenced other web pages to the content of the accessed web page;
order the accessed web pages into a ranked order based upon the number and relevance of the referenced other web pages to an accessed web page, with higher rank being given to accessed web pages to which the referenced other web pages have greater relevance; and
displaying the plurality of accessed web pages to the computer user in ranked order, with higher ranked web pages being given priority in display.

2. Method according to claim 1 wherein the determination of relevance comprises determining whether a referenced other web page contains advertising and, if so, then filtering the advertising containing web page out of further determination.

3. Method according to claim 1 wherein the operation on the data of accessed web pages comprises a determination of the reputation of an accessed web page by identifying the number of other web pages referenced in the accessed web page.

4. Method according to claim 1 wherein the determination of relevance comprises determining whether a referenced other page is referenced in a plurality of accessed web pages and, if so, assigning a ranking scoring value reflective of the number of references.

5. Method according to claim 1 wherein the determination of relevance comprises determining the extent to which the content of a referenced web page is the similar to the content of the accessed web page and assigning a ranking scoring value reflective of the degree of similarity.

6. Method according to claim 1 wherein the ordering of accessed web pages into ranked order comprises calculating a ranking score for each accessed web page from assigned ranking scoring values, where the values are represented by:
R for the reputation of the accessed web page determined by identifying the number of other web pages referenced in the accessed web page;
N for the number of times a referenced web page is referenced; and
D for the extent to which the content of a referenced web page is the similar to the content of the accessed web page;
each value being in a predetermined range of values.

7. Method according to claim 6 wherein the calculation is an iteration of summing R X N X D for each accessed web page.

8. Apparatus comprising:
an information handling system having a processor and associated memory, said system being accessible to a user of an end user device which has a processor and associated memory;
program instructions stored in memory accessible to said information handling system and effective when executing on said information handling system to:
respond to entry of a search query by a computer user into a search program executing on the end user device by accessing a plurality of web pages;
operate on the data of each of the plurality of accessed web pages to:
determine other web pages to which reference is made from an accessed web page;
determine the relevance of the referenced other web pages to the content of the accessed web page;
order the accessed web pages into a ranked order based upon the relevance of the referenced other web pages to an accessed web page, with higher rank being given to accessed web pages to which the referenced other web pages have greater relevance; and
display the plurality of accessed web pages to the computer user in ranked order, with higher ranked web pages being given priority in display.

9. Apparatus according to claim 8 wherein the determination of relevance comprises determining whether a referenced other web page contains advertising and, if so, then filtering the advertising containing web page out of further determination.

10. Apparatus according to claim 8 wherein the operation on the data of accessed web pages comprises a determination of the reputation of an accessed web page by identifying the number of other web pages referenced in the accessed web page.

11. Apparatus according to claim 8 wherein the determination of relevance comprises determining whether a referenced other page is referenced in a plurality of accessed web pages and, if so, assigning a ranking scoring value reflective of the number of references,

12. Apparatus according to claim 8 wherein the determination of relevance comprises determining the extent to which the content of a referenced web page is the similar to the content of the accessed web page and assigning a ranking scoring value reflective of the degree of similarity.

13. Apparatus according to claim 8 wherein the ordering of accessed web pages into ranked order comprises calculating a ranking score for each accessed web page from assigned ranking scoring values, where the values are represented by:
R for the reputation of the accessed web page determined by identifying the number of other web pages referenced in the accessed web page;
N for the number of times a referenced web page is referenced; and
D for the extent to which the content of a referenced web page is the similar to the content of the accessed web page;
each value being in a predetermined range of values.

14. Apparatus according to claim 13 wherein the calculation is an iteration of summing R X N X D for each accessed web page.

15. Program product for displaying ranked web pages in response to a search query, the computer program product comprising:
a tangible computer readable storage medium having computer readable program code embodied therewith, the computer readable program code comprising computer readable program code configured to:
respond to entry of a search query by a computer user into a search program executing on an end user device by accessing a plurality of web pages;
operate on the data of each of the plurality of accessed web pages to:
determine other web pages to which reference is made from an accessed web page;
determine the relevance of the referenced other web pages to the content of the accessed web page;
order the accessed web pages into a ranked order based upon the relevance of the referenced other web pages to an accessed web page, with higher rank being given to accessed web pages to which the referenced other web pages have greater relevance; and
display the plurality of accessed web pages to the computer user in ranked order, with higher ranked web pages being given priority in display.

16. Program product according to claim 15 wherein the determination of relevance comprises determining whether a referenced other web page contains advertising and, if so, then filtering the advertising containing web page out of further determination.

17. Program product according to claim 15 wherein the operation on the data of accessed web pages comprises a determination of the reputation of an accessed web page by identifying the number of other web pages referenced in the accessed web page.

18. Program product according to claim 15 wherein the determination of relevance comprises determining whether a referenced other page is referenced in a plurality of accessed web pages and, if so, assigning a ranking scoring value reflective of the number of references.

19. Program product according to claim 15 wherein the ordering of accessed web pages into ranked order comprises calculating a ranking score for each accessed web page from assigned ranking scoring values, where the values are represented by:
R for the reputation of the accessed web page determined by identifying the number of other web pages referenced in the accessed web page;
N for the number of times a referenced web page is referenced; and
D for the extent to which the content of a referenced web page is the similar to the content of the accessed web page;
each value being in a predetermined range of values.

20. Program product according to claim 19 wherein the calculation is an iteration of summing R X N X D for each accessed web page.
